(19) United States
(12) Patent Application Publication
(10) Pub. No.: US 2002/0111166 A1
(43) Pub. Date: Aug. 15, 2002

(54) Method and system for selecting a prefer red cell in a wireless communication system

(75) Inventor: Robert L. Monroe, Colorado Springs, CO (US)

Correspondence Address: Elsa Keller, Siemens Corporation, 186 Wood Avenue South, Iselin, NJ, 08830, US

(73) Assignee: Opuswave Network, Inc.

(21) Appl. No.: 09/782,100

(22) Filed: Feb. 12, 2001

(51) Int. Cl. H04Q 7/20

(52) U.S. Cl. 455/435; 455/450; 455/434

(57) ABSTRACT

A method for selecting a preferred cell in a wireless communication system is provided that includes broadcasting cell reselection parameters from the preferred cell. The cell reselection parameters include a cell reselection offset and a timer parameter. The cell reselection offset and the timer parameter comprise values such that a cell reselection criterion for the preferred cell is greater than cell reselection criteria for non-preferred cells. A location update request is received from a mobile device. A determination is made regarding whether the mobile device is authorized. The location update from the mobile device is accepted when the mobile device is authorized.

### TECHNICAL FIELD OF THE INVENTION

This invention relates generally to the field of communication systems and more particularly to a method and system for selecting a preferred cell in a wireless communication system.

### BACKGROUND OF THE INVENTION

Conventional private branch exchanges (PBXs) allow corporations, organizations and other enterprises to provide internal communication services to their personnel. This allows personnel to call each other without using an external public telephone network. Recently, wireless networks and computer networks have been integrated into PBX networks to generate private office networks that are capable of providing wireless communication to users of wireless devices within the private office network.

Disadvantages associated with these private office networks include an inability to permit a wireless device to prefer the private office network over a standard cell in the public cellular network. Thus, the wireless device will select either the private office network or a standard public cell based on which provides a better wireless signal to the wireless device. Because of this, wireless devices within the private office network cannot be assured that service will be provided by the private office network instead of by the public cellular network.

One solution that has been suggested for this problem involves Support of Localized Service Areas (SOLSA), which allows a particular cell or private office network to be selected by a wireless device. However, this solution requires a new network that is compatible with SOLSA standards, in addition to SOLSA-enabled wireless devices. Thus, SOLSA networks will not support non-SOLSA devices and standard networks will not support SOLSA devices.

### SUMMARY OF THE INVENTION

In accordance with the present invention, a method and system for selecting a preferred cell in a wireless communication system are provided that substantially eliminate or reduce disadvantages and problems associated with conventional systems. In particular, mobile devices in range of the preferred cell select the preferred cell over neighboring cells based on cell reselection parameters broadcast by the preferred cell, and mobile devices confirmed to be authorized subscribers are serviced by the preferred cell while unauthorized mobile devices are serviced by neighboring cells.

According to one embodiment of the present invention, a method for selecting a preferred cell in a wireless communication system is provided that includes broadcasting cell reselection parameters from the preferred cell. The cell reselection parameters include a cell reselection offset and a timer parameter. The cell reselection offset and the timer parameter comprise values such that a cell reselection criterion for the preferred cell is greater than cell reselection criteria for non-preferred cells. A location update request is received from a mobile device. A determination is made regarding whether the mobile device is authorized. The location update from the mobile device is accepted when the mobile device is authorized.

According to another embodiment of the present invention, a method for selecting a preferred cell in a wireless communication system is provided that includes receiving cell reselection parameters from the preferred cell. The cell reselection parameters include a cell reselection offset and a timer parameter. The cell reselection offset and the timer parameter comprise values such that a cell reselection criterion for the preferred cell is greater than cell reselection criteria for non-preferred cells. A location update is requested based on the cell reselection parameters received from the preferred cell.

Technical advantages of one or more embodiments of the present invention include providing an improved method for selecting a preferred cell in a wireless communication system. In a particular embodiment, a preferred cell may broadcast cell reselection parameters that cause mobile devices to select the preferred cell over neighboring cells. As a result, mobile devices may select the preferred cell for wireless communication based on the cell reselection parameters. A private network corresponding to the preferred cell may validate the mobile devices as authorized subscribers before providing service. Accordingly, authorized mobile devices may communicate through the preferred cell, while unauthorized mobile devices are prevented from doing so.

Other technical advantages of one or more embodiments of the present invention include providing a positive indicator to a mobile device that has selected a preferred cell as confirmation to a user of the mobile device that the selection has been approved and completed. For example, the mobile device may display a private network name or other suitable textual identifier for the private network after the mobile device is determined to be authorized and service is being provided through the preferred cell for that mobile device.

Other technical advantages will be readily apparent to one skilled in the art from the following figures, description, and claims.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a communication system in accordance with one embodiment of the present invention;

FIG. 2 is a block diagram illustrating a cellular network including a preferred cell that is operable to be selected by a mobile device of FIG. 1 in accordance with one embodiment of the present invention;

FIG. 3 is a flow diagram illustrating a method for responding to a location update request from a mobile device of FIG. 1 in accordance with one embodiment of the present invention; and

FIG. 4 is a flow diagram illustrating a method for the mobile device of FIG. 1 to select the preferred cell of FIG. 2 in accordance with one embodiment of the present invention.

### DETAILED DESCRIPTION OF THE INVENTION

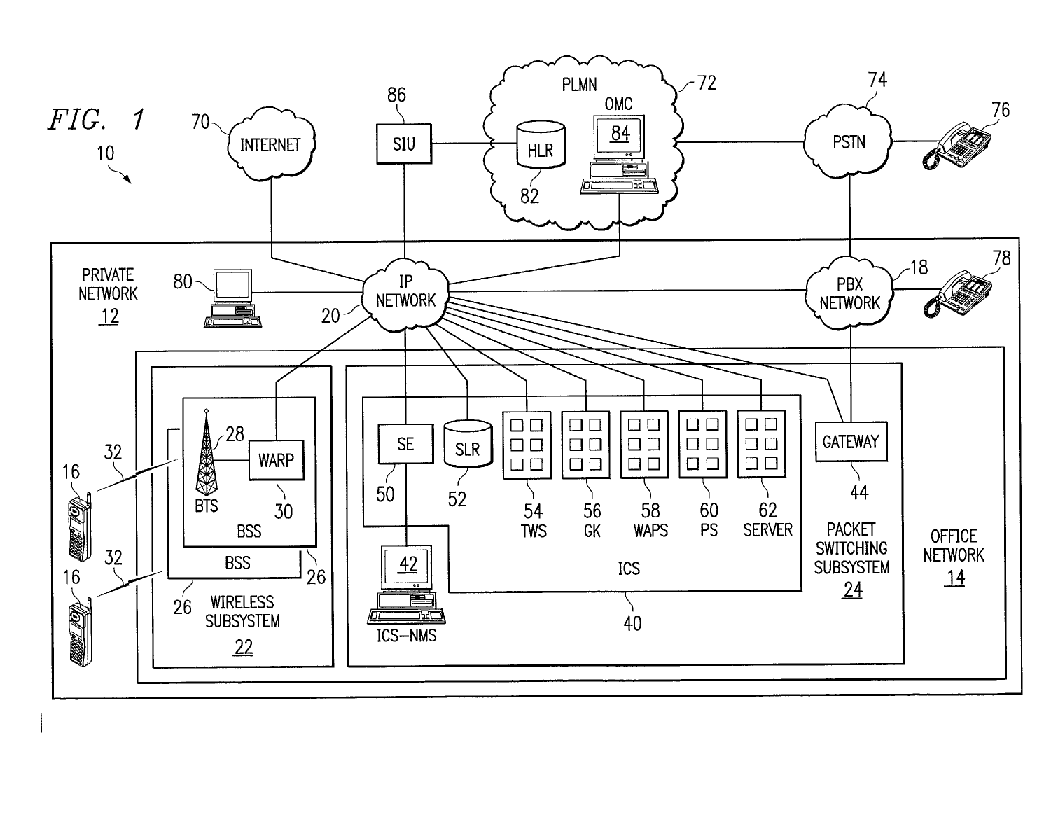

FIG. 1 is a block diagram illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAM&P) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) 30. Each base station 28 is operable to provide communication between the corresponding WARP 30 and mobile devices 16 located in a specified geographical area. As used herein, “each” means every one of at least a subset of the identified items.

Authorized mobile devices 16 are operable to provide wireless communication within the private network 12 for authorized subscribers. As described in more detail below, unauthorized mobile devices 16 are not given access to the private network 12. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAM&P functions for each of the network elements through the ICS 40. Thus, for example, an operator may perform OAM&P functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAM&P interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits, field-programmable gate arrays, digital signal processors, other suitable specific or general purpose processors, transmission media or other suitable media in which logic may be encoded and utilized. The ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

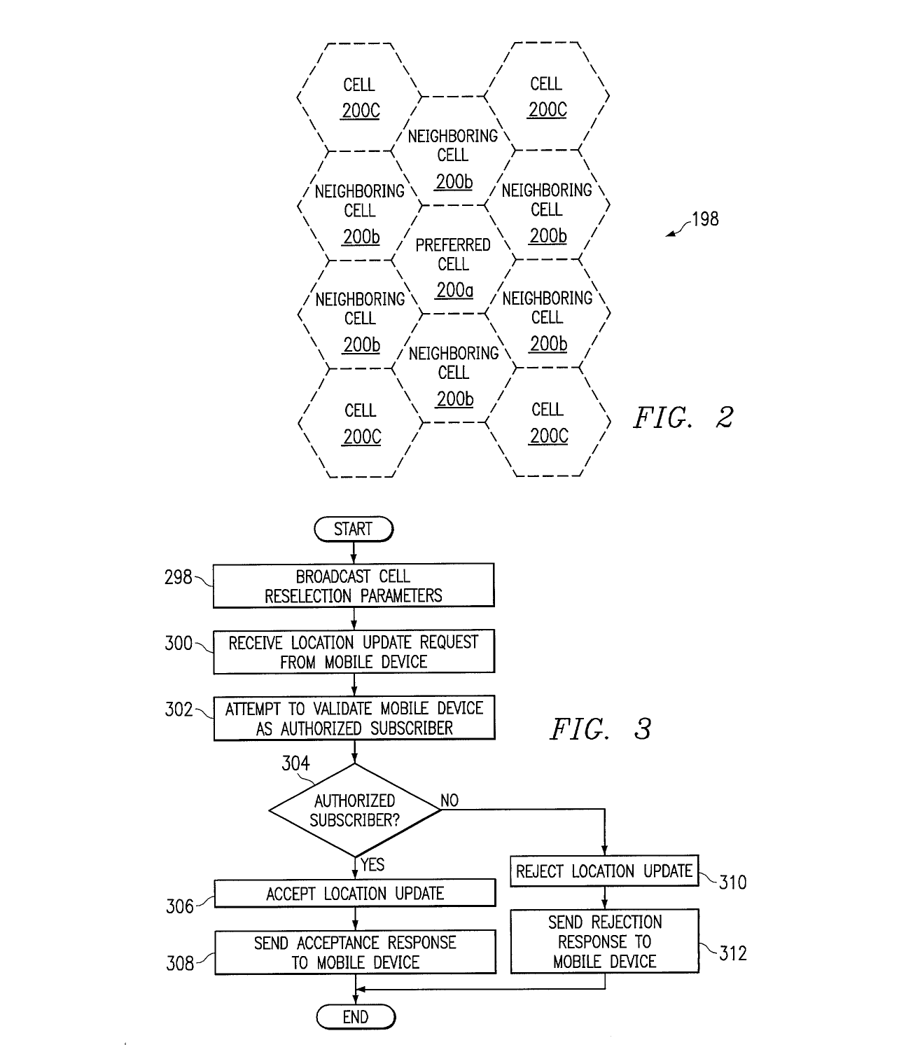

FIG. 2 is a block diagram illustrating a cellular network 198 comprising a plurality of cells 200, including a preferred cell 200a that is operable to be selected by a mobile device 16 in accordance with one embodiment of the present invention. The cellular network 198 comprises cells 200 that are within a specified coverage area for a PLMN 72. Thus, although the illustrated embodiment comprises eleven cells 200, it will be understood that the cellular network 198 may comprise any suitable number of cells 200 without departing from the scope of the present invention. In addition, the preferred cell 200a may comprise any suitable number of cells 200 within the cellular network 198, as opposed to comprising a single cell 200 as illustrated.

The cells 200 in FIG. 2 are illustrated as hexagonal areas of similar size. However, it will be understood that each cell 200 in the network 198 may comprise any suitable shape and size. In addition, although each cell 200 in the illustrated embodiment comprises six adjacent, or neighboring, cells 200, it will be understood that each cell 200 may have any suitable number of adjacent cells 200 in accordance with the shape and size of the cell 200.

In order to provide services to a mobile device 16, the PLMN 72 obtains information about the location of the mobile device 16 within the cellular network 198. The PLMN 72 may receive this location information through location updates provided by the mobile device 16, by paging the mobile device 16, or through any other suitable means.

Thus, to obtain location information from a mobile device 16, the PLMN 72 may attempt to page the mobile device 16 in every cell 200 in the entire cellular network 198. However, this results in an enormous burden on the traffic resources for the network 198. Because of this, the cellular network 198 may be subdivided into location areas, with each location area comprising one or more cells 200. For this embodiment, the PLMN 72 may attempt to page the mobile device 16 in only those cells 200 that are within a particular location area, as opposed to every cell 200 in the cellular network 198. In addition, the mobile device 16 may initiate a location update when the mobile device 16 moves from one location area into another location area, as opposed to when the mobile device 16 moves from one cell 200 to another cell 200 in order to reduce the burden on traffic resources for the network 198.

In accordance with one embodiment, the preferred cell 200a comprises a geographic area that is within range for communication with the wireless subsystem 22 of the private network 12. In addition, the preferred cell 200a is designated as a unique location area separate from the location area or areas that comprise any of the neighboring cells 200b that are adjacent to the preferred cell 200a.

Although illustrated as a separate cell 200, the preferred cell 200a may exist in one or more cells 200. Thus, the range of coverage for the neighboring cells 200b may overlap with the range of coverage for the preferred cell 200a. As described in more detail below, authorized mobile devices 16 automatically select the preferred cell 200a when in range of the preferred cell 200a. Unauthorized mobile devices 16, on the other hand, are not permitted to roam within the preferred cell 200a. Thus, an authorized mobile device 16 may communicate with the private network 12 while in the preferred cell 200a by selecting the preferred cell 200a over any of the neighboring cells 200b, and an unauthorized mobile device 16 may communicate with the PLMN 72 while in the preferred cell 200a through the overlapping coverage of one of the neighboring cells 200b.

In operation, when a mobile device 16 is turned on, the mobile device 16 initially selects a cell 200 within the coverage area of the PLMN 72 based on a specified cell selection procedure. This procedure ensures that the mobile device 16 may reliably communicate with the selected cell 200. After initially selecting a cell 200, the mobile device 16 performs a cell reselection procedure to determine when communication should be provided through a different cell 200. Thus, as the mobile device 16 moves from the coverage area of one cell 200 to another, the cell 200 providing communication for the mobile device 16 may be updated.

According to one embodiment, the cell reselection procedure for them mobile device 16 comprises synchronizing to and reading broadcast control channel (BCCH) information for the six strongest non-serving cells 200. However, it will be understood that the mobile device 16 may synchronize to and read BCCH information from any suitable number of non-serving cells 200 without departing from the scope of the present invention. Based on the BCCH information, the mobile device 16 performs measurements on each non-serving cell 200 to ensure that the serving cell 200 is acceptable.

According to the procedures set forth in GSM 03.22 version 7.3.0 and GSM 05.08 version 7.3.0 for cell selection and reselection, the mobile device 16 monitors two parameters: a path loss criterion parameter, C1, and a cell reselection criterion parameter, C2. The path loss criterion parameter is used in cell selection, while both criteria are used in cell reselection. The path loss criterion is defined as follows, with all values expressed in dBm:

C1=(A−Max(B,0)),

where A is the received level average minus the minimum received level at the mobile device 16 required for system access and B is the maximum transmission power level a mobile device 16 may use for system access minus the maximum radiofrequency output power of the mobile device 16 (plus a power offset for a class 3 DCS 1 800 mobile device 16). Using this definition, the path loss criterion is satisfied if C1>0.

The cell reselection criterion is defined as follows, with all values expressed in dBm:

C2=C1+CRO−TO*H(PT≠t), for PT≠31

C2=C1−CRO, for PT=31,

where H(x)=0 for serving cells 200 and for non-serving cells 200,

H(x)=0 for x<0

H(x)=1 for x≧0,

and where CRO is a cell reselect offset for prioritizing bands in multiband operation and TO is a temporary offset that applies for the duration of PT, which is a penalty time, after a timer, t, is started for the cell 200. According to one embodiment, CRO ranges from 0 to 63, corresponding to an offset of between 0 and 126 dB in 2 dB steps, TO ranges from 0 to 6, corresponding to an offset of between 0 and 60 dB in 10 dB steps, or TO may be 7, corresponding to an offset of infinity, and PT ranges from 0 to 30, corresponding to a penalty time of between 20 and 620 seconds in 20 second steps, or PT may be 31 to indicate that CRO is subtracted from, instead of added to, C1 and that TO is ignored. Additionally, the cell reselect hysteresis ranges from 0 to 7, corresponding to a range of 0 to 14 dB in 2 dB steps.

During cell reselection, the mobile device 16 calculates the values for C1 and C2 for the serving cell 200 and, if necessary, for the non-serving cells 200. If C1 falls below zero for a specified period of time, the path loss to the serving cell 200 has become too high. In this situation, the mobile device 16 calculates the value of C2 for the non-serving cells 200 and determines whether to make a switch based on a comparison of the values of C2 for the serving cell 200 and the non-serving cells 200. Whether or not a recent switch has occurred is also taken into account by the mobile device 16 to ensure that the serving cell 200 is not switching back and forth too quickly, such as could occur when a mobile device 16 is near the edge of a cell 200.

The BCCH information for the preferred cell 200a provides cell reselection information for the private network 12 to mobile devices 16 within range of the preferred cell 200a. This information may comprise an identification of neighboring cells 200b which are defined as neighboring cells 200b with respect to the preferred cell 200a by the PLMN 72, cell reselection parameters such as CRO, TO and PT, a cell reselection parameter indicator which indicates to the mobile device 16 whether or not cell reselection parameters are present, and any other suitable information. In accordance with one embodiment of the present invention, the private network 12 sets CRO as high as possible, PT as low as possible, and TO as low as possible. For example, the private network 12 may set CRO to 126 dB, PT to 0 seconds, and TO to 0 dB, in addition to setting the cell reselection parameter indicator to 1. It will be understood that the cell reselection parameter indicator may be set to any suitable value that indicates the presence of cell reselection parameters. It will also be understood that if either of the timer parameters, PT and TO, is set to 0, the other timer parameter may be any suitable value. In addition, the cell reselect hysteresis may be set to 0 dB in the preferred cell 200a.

Thus, based on this BCCH information for the preferred cell 200a, if the mobile device 16 is within range of the wireless subsystem 22 of the private network 12, the mobile device 16 will attempt to select the preferred cell 200a over the neighboring cells 200b. The mobile device 16 initiates a location update for the preferred cell 200a. The private network 12 determines whether or not the mobile device 16 is an authorized subscriber for the private network 12. If the mobile device 16 is authorized, the private network 12 allows the location update to be completed. However, if the mobile device 16 is not authorized, the private network 12 rejects the location request and the mobile device 16 continues to be served by one of the neighboring cells 200b.

When the location update is allowed for authorized mobile devices 16, the private network 12 also presents a private network indicator to the mobile device 16 to indicate to the user of the mobile device 16 that the location update has been completed and the mobile device 16 is in communication with the preferred cell 200a. The private network indicator may comprise a name of the private network, the preferred cell 200a, the location area, or may comprise any other suitable textual identifier for the private network 12. According to one embodiment, the private network indicator may be provided to the mobile device 16 through a Short Message Service (SMS) as specified by GSM 03.40 and/or 04.11. For example, the SMS-Cell Broadcast function may be used to present the private network indicator on the mobile device 16.

FIG. 3 is a flow diagram illustrating a method for responding to a location update request from a mobile device 16 in accordance with one embodiment of the present invention. The method begins at step 298 where the private network 12 broadcasts cell reselection and other suitable parameters over the BCCH for the preferred cell 200a. For example, the private network 12 may broadcast a CRO of 126 dB, a PT of 0 seconds, a TO of 0 dB, a cell reselect hysteresis of 0 dB, and a cell reselection parameter indicator of 1. At step 300, the private network 12 receives a location update request from a mobile device 16 that is within range of the wireless subsystem 22 for the private network 12. At step 302, the packet switching subsystem 24 attempts to validate the mobile device 16 as an authorized subscriber. For example, the packet switching subsystem 24 may perform a search of the SLR 52, or other suitable database, based on identifying data for the mobile device 16 received in the location update request.

At decisional step 304, a determination is made regarding whether or not the subscriber is authorized. For example, the subscriber may be authorized if a match is found in the SLR 52. If the subscriber is authorized, the method follows the Yes branch from decisional step 304 to step 306. At step 306, the private network 12 accepts the location update from the mobile device 16 and allows the mobile device 16 to communicate with the private network 12 through the wireless interface 32. At step 308, the private network 12 sends an acceptance response to the mobile device 16. The acceptance response may comprise, for example, a private network indicator which may be displayed on the mobile device 16 as a positive indication to the user of the mobile device 16 that the location update has been accepted. At this point, the method comes to an end.

Returning to decisional step 304, if the subscriber is not authorized, the method follows the No branch from decisional step 304 to step 310. At step 310, the private network 12 rejects the location update request from the mobile device 16 and does not allow the mobile device 16 to communicate with the private network 12. At step 312, the private network 12 sends a rejection response to the mobile device 16. The rejection response comprises a cause code that indicates that roaming for the mobile device 16 is forbidden in the location area corresponding to the preferred cell 200a. For example, the rejection response may comprise a cause code #13, “roaming not allowed in this location area,” or other suitable response forbidding roaming in the location area of the preferred cell 200a. Based on this rejection response, the mobile device 16 stores an identifier for the forbidden location area in a memory, such as a subscriber identification module (SIM) card or other suitable memory, for the mobile device 16. Thus, the mobile device 16 will not attempt another location update to the preferred cell 200a, thereby minimizing processing costs for mobile devices 16 that are not authorized to communicate within the private network 12. At this point, the method comes to an end.

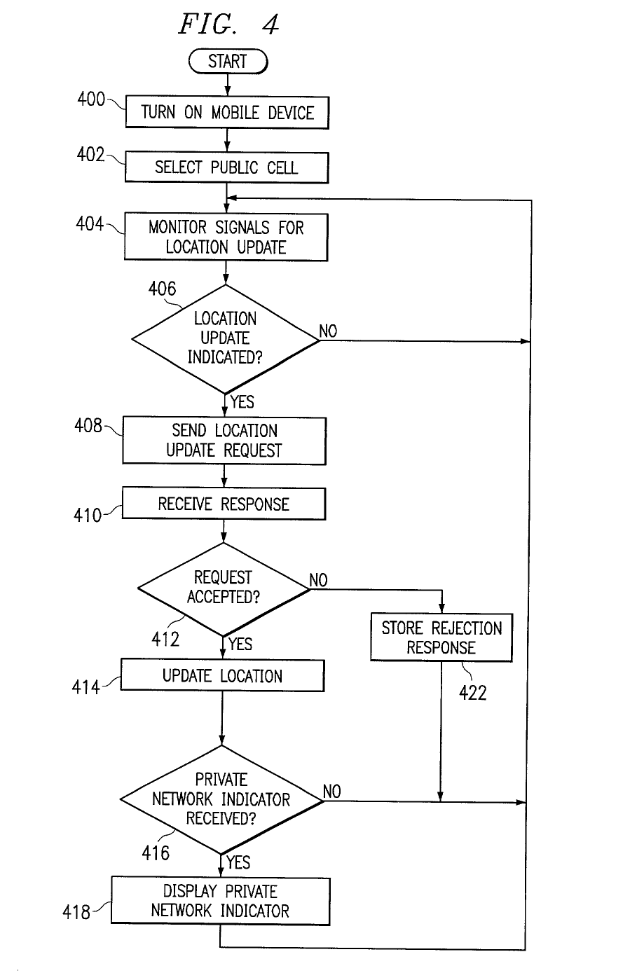

FIG. 4 is a flow diagram illustrating a method for the mobile device 16 to select the preferred cell 200a in accordance with one embodiment of the present invention. The method begins at step 400 where the mobile device 16 is turned on. At step 402, the mobile device 16 selects a cell 200 within the coverage area of the PLMN 72 based on a specified cell selection procedure. At step 404, the mobile device 16 monitors signals from a plurality of cells 200, including the serving cell 200 and several non-serving cells 200, in order to determine whether to request a location update to a new cell 200, as described in more detail above in connection with FIG. 2.

At decisional step 406, the mobile device 16 determines whether or not a location update is indicated based on the monitored signals. If no location update is indicated, the method follows the No branch from decisional step 406 and returns to step 404 to continue monitoring signals. However, if a location update is indicated, the method follows the Yes branch from decisional step 406 to step 408.

At step 408, the mobile device 16 sends a location update request to the cell 200 with which the mobile device 16 desires communication. At step 410, the mobile device 16 receives a response to the location update request from the cell 200. At decisional step 412, the mobile device 16 determines whether or not the location update request was accepted based on the response. If the location update request was accepted, the method follows the Yes branch from decisional step 412 to step 414.

At step 414, the mobile device 16 completes the location update and begins communicating with the new cell 200. At decisional step 416, the mobile device 16 determines whether or not a private network indicator was received from the new cell 200. If no private network indicator was received from the new cell 200, the mobile device 16 has not roamed into the coverage area for the preferred cell 200a and the method follows the No branch from decisional step 416 and returns to step 404 where signals are monitored for another location update.

However, if a private network indicator was received from the new cell 200, the mobile device 16 has roamed into the coverage area for the preferred cell 200a and the method follows the Yes branch from decisional step 416 to step 418. At step 418, the mobile device 16 displays the private network indicator on the mobile device 16 to inform the user of the mobile device 16 that the mobile device 16 has selected the preferred cell 200a and is communicating with the private network 12. The method then returns to step 404 where the mobile device 16 monitors signals for another location update.

Returning to decisional step 412, if the request was not accepted, the method follows the No branch from decisional step 412 to step 422. At step 422, the mobile device 16 stores at least a portion of the rejection response, if appropriate. For example, if the mobile device 16 is attempting to roam in the location area comprising the preferred cell 200a but the mobile device 16 is unauthorized, the rejection response comprises a cause code that indicates that roaming for the mobile device 16 is forbidden in the location area corresponding to the preferred cell 200a. In this situation, the mobile device 16 stores an identifier for the forbidden location area in a memory, such as a SIM card or other suitable memory, for the mobile device 16. As a result, the mobile device 16 will not attempt another location update for the same location area. The method then returns to step 404 where the mobile device 16 monitors signals for another location update. In this way, processing costs for unauthorized mobile devices 16 are minimized.

Although the present invention has been described with several embodiments, various changes and modifications may be suggested to one skilled in the art. It is intended that the present invention encompass such changes and modifications as fall within the scope of the appended claims.

What is claimed is:

1. A method for selecting a preferred cell in a wireless communication system, comprising:
broadcasting cell reselection parameters from the preferred cell, the cell reselection parameters comprising a cell reselection offset and a timer parameter, the cell reselection offset and the timer parameter comprising values such that a cell reselection criterion for the preferred cell is greater than cell reselection criteria for non-preferred cells;
receiving a location update request from a mobile device;
determining whether the mobile device is authorized; and
accepting the location update from the mobile device when the mobile device is authorized.

2. The method of claim 1, further comprising sending an acceptance response to the mobile device when the location update is accepted, the acceptance response comprising a private network indicator.

3. The method of claim 2, the private network indicator comprising a textual identifier for the private network.

4. The method of claim 1, the timer parameter comprising one of a temporary offset of 0 dB and a penalty time of 0 seconds.

5. The method of claim 1, further comprising rejecting the location update from the mobile device when the mobile device is unauthorized.

6. The method of claim 5, rejecting the location update comprising providing a cause code to the mobile device, the cause code indicating that the location area comprising the preferred cell is forbidden for roaming.

7. The method of claim 1, the cell reselection offset comprising a maximum value and the temporary offset comprising a minimum value.

8. The method of claim 1, the cell reselection offset comprising 126 dB.

9. The method of claim 1, further comprising broadcasting a cell reselection parameter indicator from the preferred cell to indicate the presence of cell reselection parameters.

10. A system for selecting a preferred cell in a wireless communication system, comprising:
a computer-processable medium; and
logic stored on the computer-processable medium, the logic operable to broadcast cell reselection parameters from the preferred cell, the cell reselection parameters comprising a cell reselection offset and a timer parameter, the cell reselection offset and the timer parameter comprising values such that a cell reselection criterion for the preferred cell is greater than cell reselection criteria for non-preferred cells; to receive a location update request from a mobile device; to determining whether the mobile device is authorized; and to accept the location update from the mobile device when the mobile device is authorized.

11. The system of claim 10, the logic further operable to send an acceptance response to the mobile device when the location update is accepted, the acceptance response comprising a private network indicator.

12. The system of claim 11, the private network indicator comprising a textual identifier for the private network.

13. The system of claim 11, the timer parameter comprising one of a temporary offset of 0 dB and a penalty time of 0 seconds.

14. The system of claim 10, the logic further operable to reject the location update from the mobile device when the mobile device is unauthorized.

15. The system of claim 14, the logic operable to reject the location update by providing a cause code to the mobile device, the cause code indicating that the location area comprising the preferred cell is forbidden for roaming.

16. The system of claim 10, the cell reselection offset comprising a maximum value and the temporary offset comprising a minimum value.

17. The system of claim 10, the cell reselection offset comprising 126 dB.

18. The system of claim 10, the logic further operable to broadcast a cell reselection parameter indicator from the preferred cell to indicate the presence of cell reselection parameters.

19. A method for selecting a preferred cell in a wireless communication system, comprising:
receiving cell reselection parameters from the preferred cell, the cell reselection parameters comprising a cell reselection offset and a timer parameter, the cell reselection offset and the timer parameter comprising values such that a cell reselection criterion for the preferred cell is greater than cell reselection criteria for non-preferred cells; and
requesting a location update based on the cell reselection parameters received from the preferred cell.

20. The method of claim 19, further comprising receiving an acceptance response from the preferred cell when the location update is accepted, the acceptance response comprising a private network indicator.

21. The method of claim 20, further comprising displaying the private network indicator, the private network indicator comprising a textual identifier for the private network.

22. The method of claim 20, the timer parameter comprising one of a temporary offset of 0 dB and a penalty time of 0 seconds.

23. The method of claim 19, further comprising receiving a rejection response from the preferred cell when the location update is rejected.

24. The method of claim 23, the rejection response comprising a cause code indicating that the location area comprising the preferred cell is forbidden for roaming.

25. The method of claim 19, the cell reselection offset comprising a maximum value and the temporary offset comprising a minimum value.

26. The method of claim 19, the cell reselection offset comprising 126 dB.

27. The method of claim 19, further comprising receiving a cell reselection parameter indicator from the preferred cell, the cell reselection parameter indicator operable to indicate the presence of cell reselection parameters.

28. A method for selecting a preferred cell in a wireless communication system, comprising:
broadcasting cell reselection parameters from the preferred cell, the cell reselection parameters comprising a cell reselection offset and a timer parameter, the cell reselection offset and the timer parameter comprising values such that a cell reselection criterion for the preferred cell is greater than cell reselection criteria for non-preferred cells, the cell reselection offset comprising a maximum value and the timer parameter comprising a minimum value;
receiving a location update request from a mobile device;
determining whether the mobile device is authorized;
accepting the location update from the mobile device when the mobile device is authorized;
sending an acceptance response to the mobile device when the location update is accepted, the acceptance response comprising a private network indicator, the private network indicator comprising a textual identifier for the private network; and
rejecting the location update from the mobile device when the mobile device is unauthorized by providing a cause code to the mobile device, the cause code indicating that the location area comprising the preferred cell is forbidden for roaming.
